(19) United States
(12) Patent Application Publication
(10) Pub. No.: US 2020/0155978 A1
(43) Pub. Date: May 21, 2020

(54) WATER PURIFYING FILTER CARTRIDGE STRUCTURE

(71) Applicant: XIAMEN FILTERTECH INDUSTRIAL CORPORATION, Xiamen (CN)

(72) Inventors: FENG-SHUN ZHAN, Xiamen (CN); DE-LIANG WANG, Xiamen (CN); JIAN-YONG YAN, Xiamen (CN)

(21) Appl. No.: 16/683,844

(22) Filed: Nov. 14, 2019

(30) Foreign Application Priority Data
Nov. 15, 2018 (CN) 201811360160.1

(51) Int. Cl. B01D 27/10

(52) U.S. Cl. CPC B01D 27/106; B01D 2221/02; B01D 27/108

(57) ABSTRACT

A water purifying filter cartridge structure includes: a filter cartridge main body and a filter cartridge bottom seat. The filter cartridge main body includes: a filter barrel, a filter barrel cover, a filter body, a filter chamber, and a back flow check component. The filter barrel cover is disposed on a top portion of the filter barrel. The filter body is adapted to remove impurities from water. The filter chamber is disposed in the filter barrel, and the back flow check component is disposed in the filter barrel. The back flow check component includes a first back flow check piece, a second back flow check piece, and a third back flow check piece. The first back flow check piece and the second back flow check piece are adapted to prevent back flow at the water input end.

### BACKGROUND OF THE INVENTION

### Field of the Invention

The preferred embodiment of the present invention relates to a filter cartridge structure, and in particular to a water purifying filter cartridge structure.

### The Prior Arts

With the rise living standard, people are more demanding about the quality of water. The quality of water affects directly the health of a person. In particular, when water is used for cooking, washing and cleaning fruits and vegetables, cooking a meal, and preparing drinking water, and it must be purified thoroughly to make sure it can be used safely.

Presently on the market, most of the faucets available do not have filter functions, so it must be installed an additional filter to provide filtering function. Yet, usually, the size of output hole for a filter is rather large, thus it can not filter water effectively, and it is not easy to wash and clean after long time usage. Further, for a faucet having installed a filter is only able to provide filtered water, and it can not provide unfiltered water, to cause inconvenience.

With the rapid industrialization of our nation, the environment has suffered greatly from the damages of various pollutions. Also, water shortage is a chronic problem, and along with environment pollutions, water shortage problem is getting increasingly serious. In this regard, in case the unfiltered faucet water is able to meet sufficiently the needs of our daily life, then water saving can be achieved. In order to satisfy the needs of our daily usages, water purifying faucets are developed. Most of the water purifying faucets presently available on the market are of a single-input single-output type, or a single-input double-output type; while the double-input double-output type water purifying faucets are rarely available.

For the double-output water purifying faucets, a water purifying filter cartridge having double-output channels is provided. A water purifying tube body is disposed between the faucet main body and a water output tube. The water input port of the water purifying tube body is connected detachably to the faucet main body. In general, the water purifying filter cartridge having double-output channels is a super filter film type filter cartridge. The water purifying tube body is connected detachably to the water output tube through an upper end cover. When in usage, the faucet main body of the water purifying faucet is connected to a faucet water tube. As such, through the filtering of the water purifying filter cartridge having double-output channels disposed in the water purifying tube body, purified faucet water can be obtained from the water output tube. The faucet water thus obtained can be drunk directly or can be used for cooking. The water purifying faucet is simple in structure, and convenient in usage, to achieve water purifying effectively. However, the filter cartridge of double-output type water purifying faucet does not have backflow checking function, so that water backflow tends to occur, to cause secondary pollution and damages to the filter cartridge.

Therefore, presently, the design and performance of the filter cartridge is not quite satisfactory, and it leaves much room for improvement.

### SUMMARY OF THE INVENTION

In view of the problems and drawbacks of the prior art, the preferred embodiment of the present invention provides a water purifying filter cartridge structure, that is able to check water back flow. For which, the filter cartridge is disposed vertically without increasing the diameter of the filter cartridge, to make the filter cartridge compact in size, to fully utilize the space in filter cartridge, and to reduce the stages of filter cartridges required, in achieving cost reduction.

The embodiment of the present invention provides a water purifying filter cartridge structure, that includes: a filter cartridge main body and a filter cartridge bottom seat. Wherein, the filter cartridge main body includes: a filter barrel, a filter barrel cover, a filter body, a filter chamber, and a back flow check component. The filter barrel cover is disposed on a top portion of the filter barrel. The filter body is adapted to remove impurities from water. The filter chamber is disposed in the filter barrel, and the back flow check component is disposed in the filter barrel. The back flow check component includes a first back flow check piece, a second back flow check piece, and a third back flow check piece. The first back flow check piece and the second back flow check piece are adapted to prevent back flow at the water input end, the third back flow check piece is disposed at a bottom portion of the filter barrel, to prevent back flow at a water output end. The filter cartridge bottom seat is disposed at a bottom portion of the filter cartridge main body, to fix and secure onto the filter cartridge main body.

In an aspect of the present invention, the filter body is disposed in the filter chamber, and the filter body includes an upper filter body and a lower filter body.

In another aspect of the present invention, the filter chamber includes a first chamber, a second chamber, a third chamber, and a fourth chamber.

In yet another aspect of the present invention, the first chamber and the second chamber are located eccentrically at one side of the filter barrel, and the second chamber is internally tangent to the first chamber.

In a further aspect of the present invention, in the first chamber is disposed an upper filter body, and the first chamber is disposed below the filter barrel cover.

In an aspect of the present invention, in the second chamber is disposed a lower filter body, and the second chamber is disposed below the first chamber.

In another aspect of the present invention, the third chamber is connected and in communication with the second chamber, and the fourth chamber is connected and in communication with the first chamber.

In yet another aspect of the present invention, the filter cartridge bottom seat includes a hanging table, a hanging table seat, and a rotation valve, the hanging table is connected to the hanging table seat.

In a further aspect of the present invention, the hanging table seat has two water inlet holes, and two water outlet holes.

In an aspect of the present invention, the rotation valve is adapted to control tight seal or communication of the two water inlet holes and two water outlet holes simultaneously.

Compared with the Prior, the present invention has the following advantages:
(1) In the water purifying filter cartridge structure of the present invention, back flow check components are disposed at water input end and water output end, to prevent back flow of input water and output water.
(2) In the water purifying filter cartridge structure of the present invention, the stages of the filter cartridge is reduced, to achieve cost reduction.
(3) In the water purifying filter cartridge structure of the present invention, a tight seal approach of large sphere and small sphere tangent to each other is used, to reduce the diameter of the filter barrel.
(4) In the water purifying filter cartridge structure of the present invention, eccentric tight seal water route is adopted to increase water input area.
(5) In the water purifying filter cartridge structure of the present invention, the filter cartridges are arranged vertically, thus there is no need to increase the diameter of the filter cartridge, to make the cartridge structure simple and compact, to fully utilize the space in the filter cartridge.

Further scope of the applicability of the present invention and embodiments thereof will become apparent from the detailed descriptions given hereafter. However, it should be understood that the detailed descriptions and specific examples, while indicating preferred embodiments of the present invention, are given by way of illustration only, since various changes and modifications within the spirit and scope of the present invention will become apparent to those skilled in the art from the detailed descriptions.

### BRIEF DESCRIPTION OF THE DRAWINGS

Embodiments of the present invention are described below, by way of example only, with reference to the accompanying drawings in which:

FIG. 1 is a schematic diagram of a water purifying filter cartridge structure according to an embodiment of the present invention; and

FIG. 2 is an exploded view of a water purifying filter cartridge structure according to an embodiment of the present invention.

### DETAILED DESCRIPTION OF THE PREFERRED EMBODIMENT

The purpose, construction, features, functions and advantages of the present invention and its embodiments can be appreciated and understood more thoroughly through the following detailed descriptions with reference to the attached drawings.

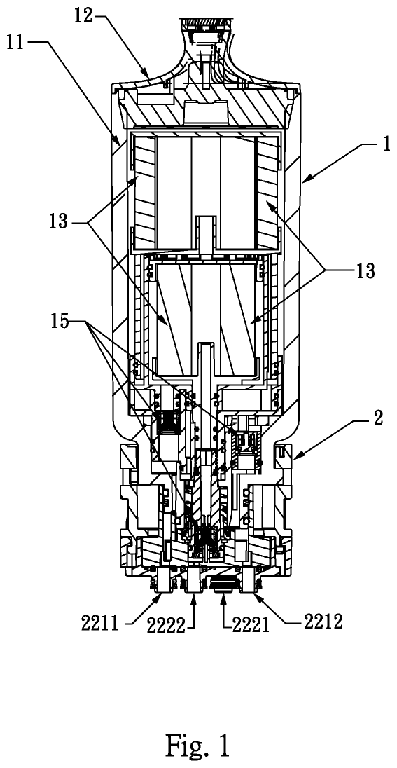

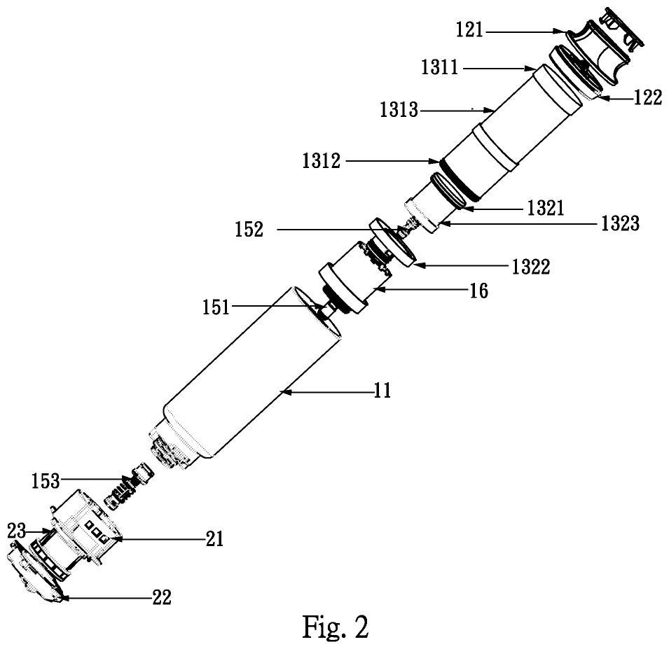

Refer to FIGS. 1 and 2 for a schematic diagram of a water purifying filter cartridge structure according to an embodiment of the present invention; and an exploded view of a water purifying filter cartridge structure according to an embodiment of the present invention. As shown in FIGS. 1 and 2, the embodiment of the present invention provides a water purifying filter cartridge structure, that includes: a filter cartridge main body 1 and a filter cartridge bottom seat 2. Wherein, the filter cartridge main body 1 includes: a filter barrel 11, a filter barrel cover 12, a filter body 13, a filter chamber 14, and a back flow check component 15, an inner flow guide sleeve 16, an O-shape tight seal ring 17, and a lower fixing seat 18.

The filter barrel cover 12 includes a filter cartridge cover 121 and a tight seal cover 122. The filter barrel cover 12 is disposed at a top portion of the filter barrel 11, and the tight seal cover 122 is disposed at a lower portion of the filter cartridge cover 121. The filter cartridge cover 121 is used to tight seal the filter barrel 11, and the tight seal cover 122 is used to tight seal the filter body 13.

The filter body 13 is disposed in the filter barrel 11. The filter body 13 includes an upper filter body 131 and a lower filter body 132. The upper filter body 131 includes an upper filter material upper cover 1311, and upper filter material lower cover 1312, and an upper filter material 1313. The lower filter body 132 includes a lower filter material upper cover 1321, a lower filter material lower cover 1322, and a lower filter material 1323.

The upper filter material upper cover 1311 and upper filter material lower cover 1312 are tight seal to the upper filter material 1313 respectively through using hot melt adhesive. The lower filter material upper cover 1321 and the lower filter material lower cover 1322 are tight seal to the lower filter material 1323 respectively through using hot melt adhesive.

The filter chamber 14 is disposed in the filter barrel 11. The filter chamber 14 includes a first chamber 141, a second chamber 142, a third chamber 143, and a fourth chamber 144.

The first chamber 141 and the second chamber 142 are located eccentrically at one side of the filter barrel 11, and the second chamber 142 is internally tangent to the first chamber 141.

The first chamber 141 is disposed at a lower portion of the tight seal cover 122. The upper filter material upper cover 1311, the upper filter material lower cover 1312, and the filter barrel 11 together form into a first chamber 141. The upper filter material 1313 is disposed in the first chamber 141.

The second chamber 142 is disposed below the first chamber 141. The lower filter material upper cover 1321 and the lower filter material lower cover 1322, and the inner flow guide sleeve 16 together form into the second chamber 142. The lower filter material 1323 is disposed in the second chamber 142.

The third chamber 143 is formed by the filter barrel 11, the O-shape tight seal ring 17, and the lower fixing seat 18. The fourth chamber 144 is formed by the inner flow guide sleeve 16 and an upper filter material 1313 sealed tightly together.

The back flow check component 15 includes a first back flow check piece 151, a second back flow check piece 152, and a third back flow check piece 153.

The first back flow check piece 151 and the second back flow check piece 152 are both check valves, and are used to check back flow at the water input end. The third chamber 143 and the first chamber 141 are connected and in communication with each other through the first back flow check piece 151. The fourth chamber 144 is connected and in communication with the second back flow check piece 152.

The third back flow check piece 153 includes a check valve and a spring. The third back flow check piece 153 is disposed at the bottom portion of the filter barrel 11, to check back flow at the water output end.

The filter cartridge bottom seat 2 includes a hanging table 21, a hanging table seat 22, and a rotation valve 23.

The hanging table 21 is of a hollow chamber structure, and is disposed at the top portion of the hanging table seat 22. The hanging table seat 22 is connected and in communication with the bottom portion of the filter body 1, while the rotation valve 23 is disposed in the hanging table 21.

At the bottom portion of the hanging table seat 22 is disposed a water inlet hole 221 and a water outlet hole 222. The water inlet hole 221 includes a first water inlet hole 2211 and a second water inlet hole 2212. The water outlet hole 222 includes a first water outlet hole 2221 and the second water outlet hole 2222.

The filter cartridge has two water routes, namely the first water route and the second water route.

In application, water flows into the third chamber 143 through the first water inlet hole 2211, and when the third chamber 143 is full of water, the water flows into the second chamber 142 through the first back flow check piece 151. In the second chamber, the water is filtered by the lower filter body 32, and the filtered water then flows into the third back flow check piece 153 through the lower filter material lower cover 322. Finally, through the third back flow check piece 153, the water flow out from the first water outlet hole 2221, to form the first water route.

In addition, in application, water flows into the second back flow check piece 152 through the second water inlet hole 2212. Then, the water flows into the first chamber 141 through the second back flow check piece 152. In the first chamber 141, the water is filtered by the upper filter body 131. Then, the filtered water flows into the fourth chamber 144 through the upper filter material lower cover 1312. Finally, the water flows from the fourth chamber 144 into the third back flow check piece 153, to flow out from the second water outlet hole 2222, to form the second water route.

The rotation valve 23 is adapted to control tight seal or communication of the two water inlet holes 221 and two water outlet holes 222 simultaneously.

In the present invention, the filter cartridge main body 1 brings the rotation valve 23 into rotation through the slot of the hanging table 21. When the filter cartridge main body 1 is rotated into a position corresponding to the water inlet hole 221 and water outlet hole 222 on the hanging table 22, the filter cartridge main body 1 and the filter cartridge bottom seat 2 are connected to and in communication with each other. At this time, the hanging table 22 pushes the third back flow check piece 153 to open, to form the first water route and the second water route.

The present invention provides a water purifying filter cartridge structure, that is capable of achieving double water inputs and double water outputs. Back flow check components are disposed at water input end and water output end, to prevent back flow of input water and output water, to facilitate filter cartridge detachment, reduce filter cartridge stages, and reduce production cost. In the present invention, the filter cartridge adopts a vertical arrangement, to fully utilize space in the filter cartridge structure. Further, the present invention utilizes an eccentricity design, to reduce diameter of the tight seal ring, and the diameter of the filter cartridge.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A water purifying filter cartridge structure, comprising: a filter cartridge main body and a filter cartridge bottom seat, wherein
the filter cartridge main body includes: a filter barrel, a filter barrel cover, a filter body, a filter chamber, and a back flow check component, the filter barrel cover is disposed on a top portion of the filter barrel, the filter body is adapted to remove impurities from water, the filter chamber is disposed in the filter barrel, and the back flow check component is disposed in the filter barrel; the back flow check component includes a first back flow check piece, a second back flow check piece, and a third back flow check piece, the first back flow check piece and the second back flow check piece are adapted to prevent back flow at the water input end, and the third back flow check piece is disposed at a bottom portion of the filter barrel, to prevent back flow at a water output end; and
the filter cartridge bottom seat is disposed at a bottom portion of the filter cartridge main body, to fix and secure onto the filter cartridge main body.

2. The water purifying filter cartridge structure as claimed in claim 1, wherein the filter body is disposed in the filter chamber, and the filter body includes an upper filter body and a lower filter body.

3. The water purifying filter cartridge structure as claimed in claim 2, wherein the filter chamber includes a first chamber, a second chamber, a third chamber, and a fourth chamber.

4. The water purifying filter cartridge structure as claimed in claim 3, wherein the first chamber and the second chamber are located eccentrically at one side of the filter barrel, and the second chamber is internally tangent to the first chamber.

5. The water purifying filter cartridge structure as claimed in claim 3, wherein in the first chamber is disposed an upper filter body, and the first chamber is disposed below the filter barrel cover.

6. The water purifying filter cartridge structure as claimed in claim 3, wherein in the second chamber is disposed a lower filter body, and the second chamber is disposed below the first chamber.

7. The water purifying filter cartridge structure as claimed in claim 3, wherein the third chamber is connected and in communication with the second chamber, and the fourth chamber is connected and in communication with the first chamber.

8. The water purifying filter cartridge structure as claimed in claim 1, wherein the filter cartridge bottom seat includes a hanging table, a hanging table seat, and a rotation valve, the hanging table is connected to the hanging table seat.

9. The water purifying filter cartridge structure as claimed in claim 8, wherein the hanging table seat has two water inlet holes, and two water outlet holes.

10. The water purifying filter cartridge structure as claimed in claim 9, wherein the rotation valve is adapted to control tight seal or communication of the two water inlet holes and two water outlet holes simultaneously.
